(19) United States
(12) Patent Application Publication
(10) Pub. No.: US 2009/0016192 A1
(43) Pub. Date: Jan. 15, 2009

(54) RADIAL POSITION REGISTRATION FOR NON-DATA SIDE OF OPTICAL DISC

(76) Inventors: William Wang, Kweishan (TW); Jerome Wu, Kweishan (TW); Hank Yang, Kweishan (TW); Lester Chen, Kweishan (TW); Tzu-Pang Chiang, Kweishan (TW); Ta-Yuan Lee, Kweishan (TW)

Correspondence Address: HOFFMAN WARNICK LLC, 75 STATE STREET, 14TH FLOOR, ALBANY, NY, 12207, US

(21) Appl. No.: 11/775,260

(22) Filed: Jul. 10, 2007

(51) Int. Cl. G11B 7/00

(52) U.S. Cl. 369/110.04

(57) ABSTRACT

The invention provides reference patterns marked on a non-data side of an optical disc. When the optical disc, according to the invention, is installed within an optical information recording apparatus, the reference patterns enable an optical pick-up unit of the optical information recording apparatus to register at at least one reference radial position on the no-data side of the optical disc. The at least one reference radial position is for assisting the optical pick-up unit to record a label on the non-data side of the optical disc.

### BACKGROUND OF THE INVENTION

1. Field of the Invention

The present invention relates generally to an optical disc constructed reference patterns on the non-data side, and more particularly, to a method for registering an optical pick-up unit of an optical information recording apparatus at at least one reference radial position on the non-data side of the optical disc.

2. Description of the Prior Art

As recordable optical discs, such as a CD-R (compact disk recordable) and a CD-RW (compact disk rewritable), have been extensively used for recording a large amount of information, the accompanying issue is the management of optical discs that have already recorded data.

Methods for labeling the non-data side of such optical discs with text and images, for example, have continued to develop as consumers desire more convenient ways to identify the data they have burned onto their own CDs. Basic methods for labeling a disc include physically writing on the non-data side with a permanent marker (e.g. a sharpie marker) or printing out a paper sticker label and sticking it onto the non-data side of the disc. Other physical marking methods developed for implementation in conventional CD players include ink jet, thermal wax transfer, and thermal dye transfer methods. Still other methods use laser in a conventional CD player to mark a specially prepared CD surface. Such methods can be applied in the same way on CD-R, CD+R, CD-RW, DVD-R, DVD+R, DVD-RW to label CDs and DVDs.

A problem in labeling CDs is that there are no tracks or any other markings on the label surface (i.e. the non-data side, or top side) for assisting radial registration. For example, the radial registration of a laser spot, for starting to label or for adding a notation for a label constructed previously, may result in misapplying labels. For instance, a label may overlap itself if the label is printed at a radius too close to the inner diameter of the CD. Likewise, a label may have gaps if the label data is printed at a radius too far from the inner diameter of the CD.

Therefore, the need exists for a way to determine radial registration on surfaces, such as the non-data or label surface, of optical discs with no tracks or any other markings. U.S. patent application Ser. No. 10/347,074 discloses the method of printing reference patterns, such as sawtooth patterns or triangular patterns, on the non-data side (or label side) of an optical disc, enabling optical disc devices to register a laser spot at an absolute radial position on the non-data side of an optical disc. However, said prior art does not consider that the patterns adopted therein are applied to perpendicular coordinates (i.e. a plane constructed with x axis and y axis). Applying the patterns to polar coordinates (i.e. a plane constructed with r axis and θ axis) might result in the distortion of the patterns. According to the distorted patterns marked on the optical disc of the prior art, the length between the absolute radial position where the laser spot is registered on the non-data side of the optical disc and the center of the optical disc will be shorter than the length between the actual absolute radial position and the center of the optical disc. The inaccuracy will be increased as the length between the radial position and the center of the optical disc increases.

Accordingly, one scope of the invention is to provide an optical disc comprising reference patterns on the non-data side (or the label side) of itself, and more particularly, the reference patterns are non-distorted patterns.

Accordingly, another scope of the invention is to provide a method for registering an optical pick-up unit of an optical information recording apparatus at at least one reference radial position on the non-data side (or the label side) of the optical disc with the non-distorted reference patterns.

### SUMMARY OF THE INVENTION

According to the first preferred embodiment of the present invention, an optical disc comprises a data side and a non-data side. The data side is configured to store data, and the non-data side is configured to receive a label, such as text and images. N repeated patterns are arranged in an annular region on the non-data side of the optical disc, wherein N is a natural number. Each of the patterns is constructed by a respective first mark with a first reflectivity and a respective second mark with a second reflectivity. The annular region is determined by a first radius (R1) and a second radius (R2) which is larger than the first radius (R1), Each of the first marks covers a respective first arc (A1) determined by a variable radius (r), and each of the second marks covers a respective second arc (A2) determined by the variable radius (r). The variable radius (r) is in a range from the first radius (R1) to the second radius (R2).

According to the first preferred embodiment of the invention, a registering method of the optical disc includes a first step to direct a laser spot emitted by the optical pick-up unit onto the patterns while the optical disc rotates. Next, a reflected light is sensed while the patterns pass the laser spot. Afterward, the reflected light is converted into a reflectivity signal. In the next, a duty ratio of the reflectivity signal is being monitored. Afterward, according to the comparison of the duty ratio and a first predetermined value, the laser spot is selectively moved either in a first radial direction or in a second radial direction opposite to the first radial direction. Finally, the optical pick-up unit is registered at a first reference radial position of the at least one reference radial position. At the first reference radial position, the duty ratio of the reflectivity signal is equal to the first predetermined value. The registering method further performs a step to move the laser spot in the second radial direction; then, the optical pick-up unit is registered at a second reference radial position of the at least one reference radial position. At the second reference radial position, the duty ratio of the reflectivity signal is equal to a second predetermined value. The registering method according to the invention further performs another step to move the laser spot in the first radial position, and the optical pick-up unit is then registered at a third reference radial position of the at least one reference radial position. At the third reference radial position, the duty ratio of the reflectivity signal is equal to a third predetermined value.

According to the second preferred embodiment of the invention, an optical disc comprises a data side and a non-data side. The data side is configured to store data. The non-data side is configured to receive a label, such as text and images. N repeated first patterns are arranged in a first annular region on the non-data side of the optical disc, wherein N is a natural number. Each of the first patterns is constructed by a respective first mark with a first reflectivity and a respective second mark with a second reflectivity. The first annular region is determined by both of a first radius (R1) and a second radius (R2) larger than the first radius (R1). Each of the first marks covers a respective first arc (A1) determined by a first variable radius (r1), and each of the second marks covers a respective second arc (A2) determined by the first variable radius (r1). The first variable radius (r1) is in a range from the first radius (R1) to the second radius (R2). M repeated second patterns are arranged in a second annular region on the non-data side of the optical disc, wherein M is a natural number. Each of the second patterns is constructed by a respective third mark with a third reflectivity and a respective fourth mark with a fourth reflectivity. The second annular region is determined by the second radius (R2) and a third radius (R3) larger than the second radius (R2). Each of the third marks covers a respective third arc (A3) determined by a second variable radius (r2), and each of the fourth marks covers a respective fourth arc (A4) determined by the second variable radius (r2). The second variable radius (r2) is in a range from the second radius (R2) to the third radius (R3).

According to the second preferred embodiment of the invention, a registering method of an optical disc includes a first step to direct a laser spot emitted by the optical pick-up unit onto the first patterns or the second patterns while the optical disc rotates. Next, a reflected light is sensed while the first patterns or the second patterns pass the laser spot. Afterward, the reflected light is converted into a reflectivity signal. Next, a duty ratio of the reflectivity signal is monitored. Afterward, according to the variation of the duty ratio of the reflectivity signal, the laser spot is selectively moved either in a first radial direction or in a second radial direction opposite to the first radius direction. Finally, the optical pick-up unit is registered at a first reference radial position of the at least one reference radial position. At the first reference radial position, the duty ratio of the reflectivity signal is equal to the first predetermined value. The registering method further performs a step to move the laser spot along the second radial direction, and next, the optical pick-up unit is registered at a second reference radial position of the at least one reference radial position. At the second reference radial position, the duty ratio of the reflectivity signal is equal to a second predetermined value. The registering method, according to the invention, further performs a step to move the laser spot in the first radial position, and next, the optical pick-up unit is registered at a third reference radial position of the at least one reference radial position. At the third reference radial position, the duty ratio of the reflectivity signal is equal to the second predetermined value.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A is a cross-sectional diagram illustrating the structure of an optical disc, wherein the optical disc comprises a data side and a non-data side.

FIG. 1B is an illustration of the first preferred embodiment of the present invention illustrating the non-data side of the optical disc 1 in FIG. 1A, and in FIG. 1B, the patterns arranged on the extreme inner radius on the non-data side of the optical disc 1 are marked out.

FIG. 1C is another illustration of the first preferred embodiment of the present invention illustrating the non-data side of the optical disc 1 shown in FIG. 1A, and in FIG. 1C, the patterns arranged on the extreme outer radius on the non-data side of the optical disc 1 are marked out.

FIG. 2A is a flow chart illustrating a method for the registration of the optical disc according to the first preferred embodiment of the present invention.

FIG. 2B illustrates a laser spot is directed onto the patterns of the optical disc shown in FIG. 1B and FIG. 1C, so as to sense a reflected light, and the reflected light is converted into a reflectivity signal 24.

FIG. 3A is an illustration of the second preferred embodiment of the present invention, illustrating the non-data side of the optical disc shown in FIG. 1A, and in FIG. 3A, the patterns arranged on the extreme inner radius on the non-data side of the optical disc are marked out.

FIG. 3B is another illustration of the second preferred embodiment of the present invention, illustrating the non-data side of the optical disc shown in FIG. 1A, and in FIG. 3B, the patterns arranged on the extreme outer radius on the non-data side of the optical disc are marked out.

FIG. 4A is the flow chart illustrating a method for the registration of the optical disc according to the second preferred embodiment of the present invention.

FIG. 4B illustrates a laser spot is directed onto the patterns of the optical disc in FIG. 3A and FIG. 3B, so as to sense a reflected light, and the reflected light is converted into a reflectivity signal.

### DETAILED DESCRIPTION OF THE INVENTION

The present invention provides an optical disc comprising reference patterns marked on the non-data side (or the label side) of itself, and more particularly, the reference patterns are non-distorted patterns. In addition, the invention provides a method for registering an optical pick-up unit of an optical information recording apparatus at at least one reference radial position on the non-data side (or the label side) of the optical disc by means of the non-distorted reference pattern. Several preferred embodiments are disclosed as follows.

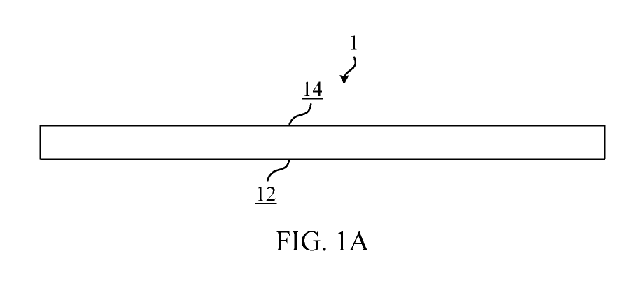

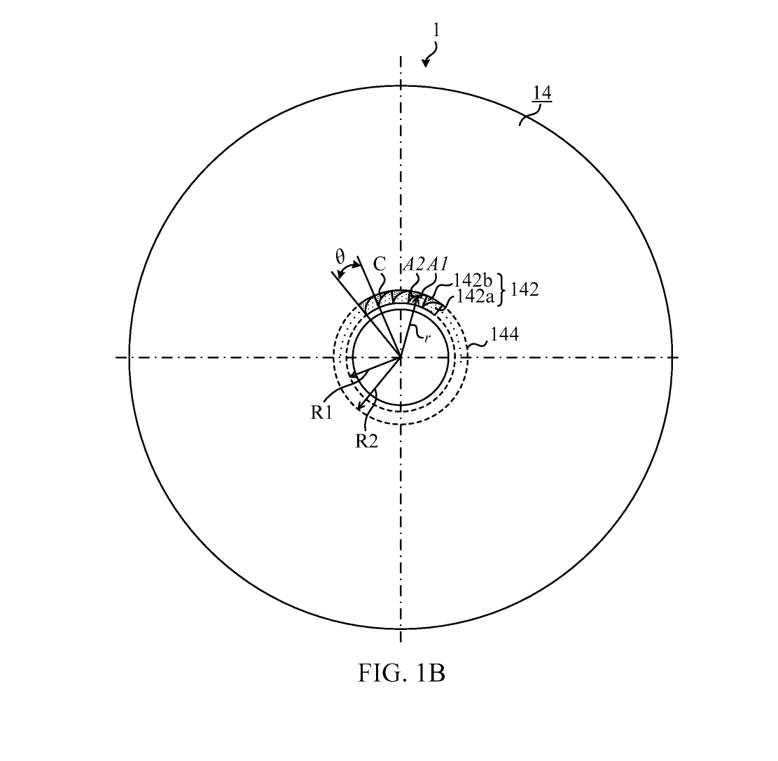

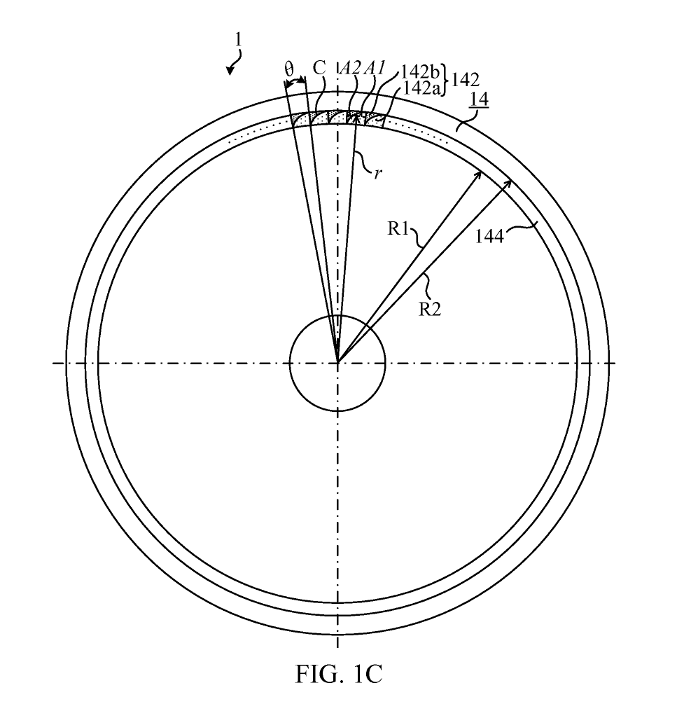

Please refer to FIG. 1A to FIG. 1C, wherein the optical disc 1 is shown according to the first preferred embodiment of the invention.

As shown in FIG. 1A, the optical disc 1 comprises a data side 12 and a non-data side 14. The data side 12 is configured to store data. The non-data side 14 is configured to receive a label, such as text and images.

As shown in FIG. 1B, N repeated patterns 142 are arranged in an annular region 144 on the non-data side 14 of the optical disc 1, wherein N is a natural number. Each of the patterns 142 is constructed by a respective first mark 142a with a first reflectivity and a respective second mark 142b with a second reflectivity. The annular region 144 is determined by a first radius (R1) and a second radius (R2) larger than the first radius (R1). Each of the first marks 142a covers a respective first arc (A1) determined by a variable radius (r), and each of the second marks 142b covers a respective second arc (A2) determined by the variable radius (r). The variable radius (r) is in a range from the first radius (R1) to the second radius (R2). It has to be emphasized that the first arc (A1) is defined as the arc formed by the circle constructed by the variable radius (r) intersecting each of the first marks 142a, and the second arc (A2) is defined as the arc formed by the circle constructed by the variable radius (r) intersecting each of the second marks 142b.

In one embodiment, the first reflectivity is higher than the second reflectivity, as shown in FIG. 1B. In addition, in the identical pattern 142, the curve (C) between the first marks 142a and the second pattern 142b is pre-calculated, so that the ratio between the length of the first arc (A1) of each first mark (142a) and the length of the second arc (A2) of each second mark (142b) neighboring the first mark (142a) is directly proportional to (r−R1)/(R2−R1). In another embodiment, the first reflectivity is lower than the second reflectivity. In addition, in the identical pattern 142, the curve (C) between the first marks 142a and the second pattern 142b is pre-calculated, so that the ratio between the length of the first arc (A1) of each first mark (142a) and the length of the second arc (A2) of each second mark (142b) neighboring the first mark (142a) is inversely proportional to (r−R1)/(R2−R1).

As shown in FIG. 1B, the patterns 142 are used for assisting in registering the extreme inner boundary of the recordable area for labeling on the non-data side 14 of the optical disc 1. In other words, the first radius (R1) is substantially equal to an extreme inner radius of the optical disc 1.

As shown in FIG. 1C, the patterns 142 can be used to assist in registering the extreme outer boundary of the recordable area for labeling on the non-data side 14 of the optical disc 1. In other words, the second radius (R2) is substantially equal to an extreme outer radius of the optical disc 1. Additionally, the units, the patterns, and the locations shown in FIG. 1C are the same as those with the same marks in FIG. 1B, and the related description will not be mentioned again here. It must be emphasized that, in FIG. 1C, the ratio between the length of the first arc (A1) of each first mark 142a and the length of the second arc (A2) of each second mark 142b neighboring the first mark 142a is either directly or inversely proportional to (r1−R1)/(R2−R1). Accordingly, the change of the radial position (on the extreme inner radius or on the extreme outer radius) on the optical disc 1 will not result in distortions of the patterns 142.

In one embodiment, each of the patterns 142 is a respective annular sector pattern. As shown in FIG. 1B and FIG. 1C, each the annular sector pattern 142 is determined by a central angle (θ) associated with the optical disc 1, and N is an integer equal to 2π/θ.

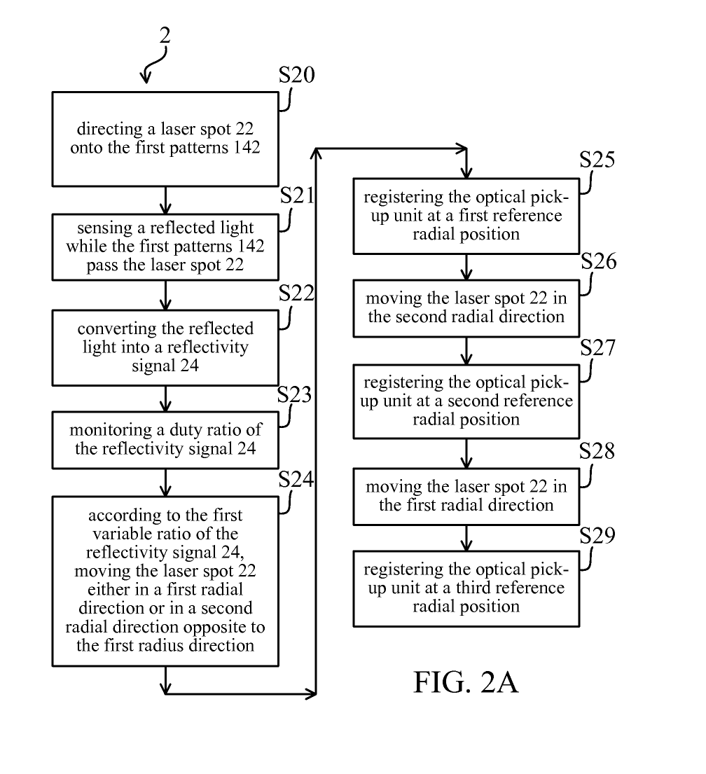

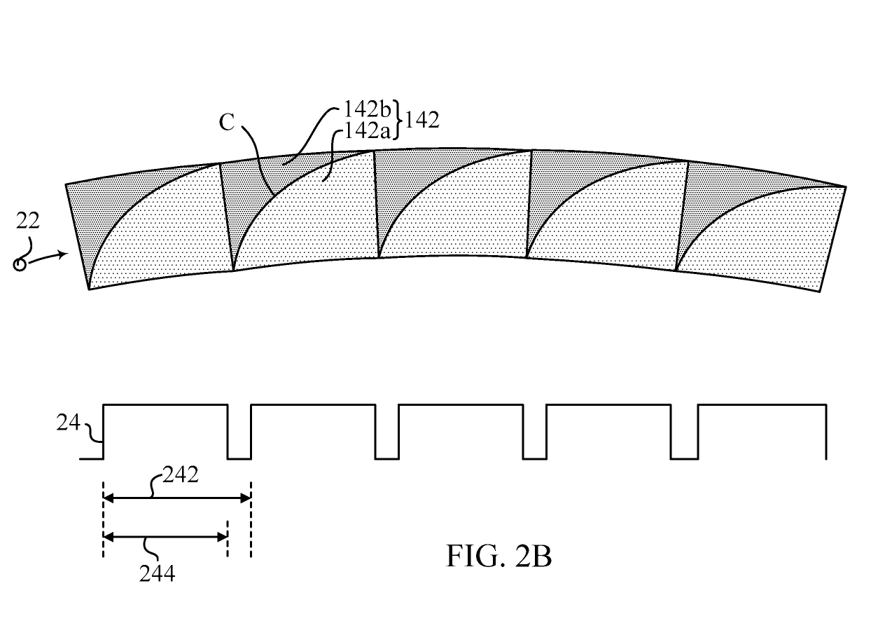

Please refer to FIG. 2A and FIG. 2B. Those two figures disclose the flow chart of the method 2 for registering the optical disc 1 according to the preferred embodiment of the invention. The registering method 2 registers an optical pick-up unit (not shown in the figures) of an optical information recording apparatus (not shown in the figures) at at least one reference radial position on the non-data side (or the label side) 14 of the optical disc 1.

As shown in FIG. 2A and FIG. 2B, the registering method 2 performs step S20 first. The step S20 directs a laser spot 22 emitted by the optical pick-up unit onto the patterns 142, in accordance with the first preferred embodiment of the invention, while the optical disc rotates.

Next, the step S21 is performed to sense a reflected light while the patterns 142 pass the laser spot 22.

Next, the step S22 is performed to convert the reflected light into a reflectivity signal 24, as shown in FIG. 2B.

Then, the step S23 is performed to monitor a duty ratio of the reflectivity signal 24, namely to monitor the ratio between the pulse duration 244 and the pulse period 242 shown in FIG. 2B.

A point for attention is that in the identical patterns 142, the curve (C) between the first marks 142a and the second marks 142b is pre-calculated, so that the duty ratio is equal to a variable ratio between the length of the first arc (A1) of each first mark (142a) and the length of the second arc (A2) of each second mark (142b) neighboring the first mark (142a).

After the step S23, the step S24 is performed to move the laser spot 22 either in a first radial direction or in a second radial direction, opposite to the first radius direction, in accordance with the comparison of the duty ratio of the reflectivity signal 24 and a first predetermined value.

In one embodiment, the variable ratio is directly proportional to (r−R1)/(R2−R1). In step S24 of this case, if the duty ratio of the reflectivity signal is smaller than the first determined value, the laser spot 22 is moved in the first radial direction. If the duty ratio is larger than the first determined value, the laser spot 22 is moved in the second radial direction. In another embodiment, the variable ratio is inversely proportional to (r−R1)/(R2−R1). In step S24 of this case, if the duty ratio of the reflectivity signal is larger than the first determined value, the laser spot 22 is moved in the first radial direction. If the duty ratio is smaller than the first determined value, the laser spot 22 is moved in the second radial direction.

Finally, the step S25 is performed to register the optical pick-up unit at a first reference radial position of the at least one reference radial position. At the first reference radial position, the duty ratio of the reflectivity signal 24 is equal to the first predetermined value.

In practical applications, the first reference radial position can determine the extreme inner boundary of the recordable area for labeling on the non-data side 14 of the optical disc 1, and meanwhile, the first radius (R1) is substantially equal to an extreme inner radius of the optical disc 1. Likewise, the first reference radial position can determine the extreme outer boundary of the recordable area for labeling on the non-data side 14 of the optical disc 1, and meanwhile, the first radius (R1) is substantially equal to an extreme outer radius of the optical disc 1.

Furthermore, the technique of generating a plurality of dots for labeling on the non-data side of an optical disc with a laser beam provided by the prior art has already been developed into the technique for generating a plurality of dots on the non-data side of an optical disc with a laser beam wobbling in the radial direction. Please refer to the U.S. patent application Ser. No. 10/447,736 for the details of the said technique, and the related description will not be mentioned again here.

However, besides registering the essential radial position, applying the technique for generating a plurality of dots on the non-data side of an optical disc with a laser beam wobbling in the radial direction requires the registering of other radial reference positions, so as to control precisely the amplitude of the laser beam departing from the inner diameter of the optical disc, and also to control the amplitude of the laser beam approaching the inner radius of the optical disc.

Accordingly, as shown in FIG. 2A, in one embodiment, the registering method 2 further performs the step S26. The step S26 is performed to move the laser spot 22 in the second radial direction. Next, the step S27 is performed to register the optical pickup unit at a second reference radial position of the at least one reference radial position. At the second reference radial position, the duty ratio of the reflectivity signal 24 is equal to a second predetermined value.

Furthermore, as shown in FIG. 2A, in one embodiment, the registering method 2 farther performs the step S28. The step S28 is performed to move the laser spot 22 in the first radial direction. Next, the step S29 is performed to register the optical pick-up unit at a third reference radial position of the at least one reference radial position. At the third reference radial position, the duty ratio of the reflectivity signal 24 is equal to a third predetermined value.

In one embodiment the first predetermined value is equal to 50%, the second predetermined value is equal to 25%, and the third predetermined is equal to 75%. In this embodiment, the first reference radial position determined by the first predetermined value can be used to determine the extreme inner boundary or the extreme outer boundary of the recordable area for labeling on the non-data side 14 of the optical disc 1. The second reference radial position determined by the second predetermined value can be used to determine the amplitude of the laser beam departing from the inner diameter of the optical disc. The third reference radial position determined by the third predetermined value can be used to determine for the amplitude of the laser beam approaching the inner diameter of the optical disc.

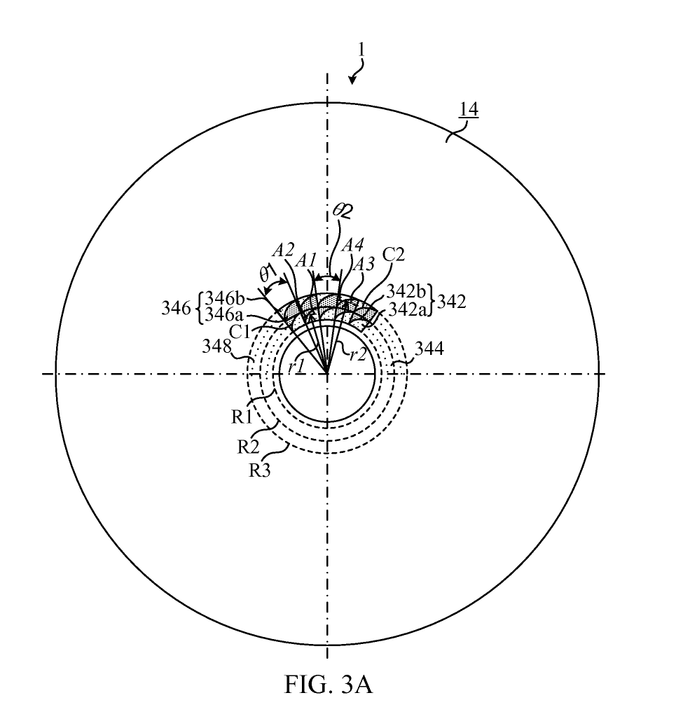

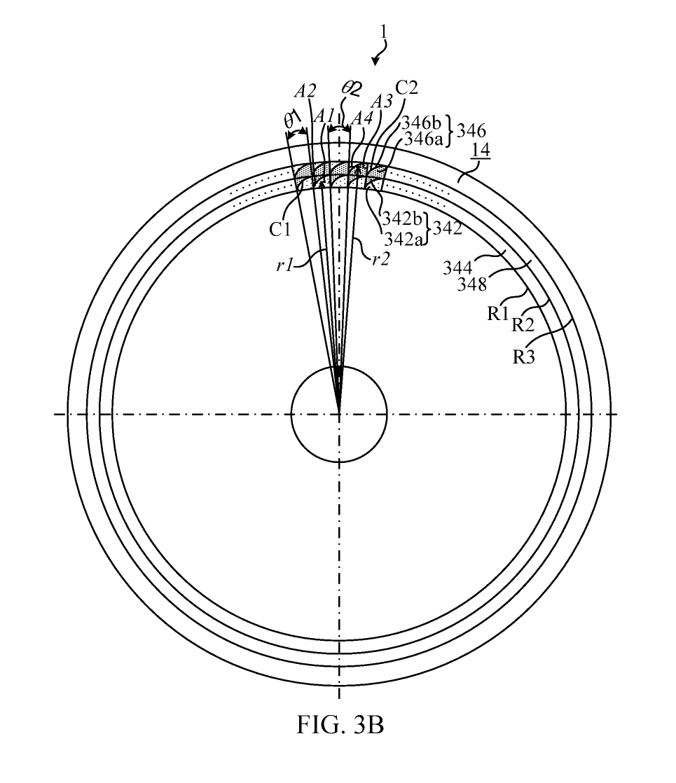

Please refer to FIG. 3A to FIG. 3B, wherein the optical disc 1 is shown according to the second preferred embodiment of the invention.

As shown in FIG. 3A, the difference between the second preferred embodiment and the previously described preferred embodiment is that N repeated first patterns 342 are arranged in a first annular region 344 on the non-data side 14 of the optical disc 1, wherein N is a natural number. Each of the first patterns 342 is constructed by a respective first mark 342a with a first reflectivity and a respective second mark 342b with a second reflectivity. The first annular region 344 is determined by a first radius (R1) and a second radius (R2) larger than the first radius (R1). Each of the first marks 342a covers a respective first arc (A1) determined by a first variable radius (r1), and each of the second marks 342b covers a respective second arc (A2) determined by the first variable radius (r1). The first variable radius (r1) is in a range from the first radius (R1) to the second radius (R2).

As shown in FIG. 3A, M repeated second patterns 346 are arranged in a second annular region 348 on the non-data side 14 of the optical disc 1, wherein M is a natural number. Each of the second patterns 346 is constructed by a respective third mark 346a with a third reflectivity and a respective fourth mark 346b with a forth reflectivity. The first annular region 348 is determined by the second radius (R2) and by a third radius (R3) larger than the second radius (R2). Each of the third marks 346a covers a respective third arc (A3) determined by a second variable radius (r2), and each of the third marks 346b covers a respective fourth arc (A4) determined by the second variable radius (r2). The second variable radius (r2) is in a range from the second radius (R2) to the third radius (R3).

In one embodiment, the first reflectivity is higher than the second reflectivity, and the third reflectivity is lower than the fourth reflectivity, as shown in FIG. 3A. In addition, in the identical first pattern 342, the curve (C1) between the first mark 342a and the second mark 342b is pre-calculated, so that a first ratio between the length of the first arc (A1) of each first mark (342a) and the length of the second arc (A2) of each second mark (342b) neighboring said first mark (342a) is directly proportional to (r1−R1)/(R2−R1). In the identical second pattern 346, the curve (C2) between the third mark 346a and the fourth mark 346b is pre-calculated, so that a second ratio between the length of the third arc (A3) of each third mark (346a) and the length of the fourth arc (A4) of each fourth mark (346b) neighboring said third mark (346a) is inversely proportional to (r2−R2)/(R3−R2).

In another embodiment, the first reflectivity is lower than the second reflectivity, and the third reflectivity is higher than the fourth reflectivity. In addition, in the identical first pattern 342, the curve (C1) between the first mark 342a and the second mark 342b is pre-calculated, so that a first ratio between the length of the first arc (A1) of each first mark (342a) and the length of the second arc (A2) of each second mark (342b) neighboring said first mark (342a) is inversely proportional to (r1−R1)/(R2−R1). In the identical second pattern 346, the curve (C2) between the third mark 346a and the fourth mark 346b is pre-calculated, so that a second ratio between the length of the third arc (A3) of each first mark (346a) and the length of the fourth arc (A4) of each fourth mark (346b) neighboring said third mark (346a) is directly proportional to (r2−R2)/(R3−R2).

As shown in FIG. 3A, the first patterns 342 are used for assisting in registering the extreme inner boundary of the recordable area for labeling on the non-data side 14 of the optical disc 1. In other words, the first radius (R1) is substantially equal to an extreme inner radius of the optical disc 1.

As shown in FIG. 3B, the second patterns 346 are capable of assisting in registering the extreme outer boundary of the recordable area for labeling on the non-data side 14 of the optical disc 1. In other words, the third radius (R3) is substantially equal to an extreme outer radius of the optical disc 1. Additionally, the units, the patterns and the locations shown in FIG. 3B are the same as those with the same marks in FIG. 3A, and the related description will not be mentioned again here. It must be emphasized that the first ratio between the length of the first arc (A1) of each first mark 342a and the length of the second arc (A2) of each second mark 342b neighboring said first mark 342a is either directly or inversely proportional to (r1−R1)/(R2−R1), in FIG. 3B. The second ratio between the length of the third arc (A3) of each third mark 346a and the length of the fourth arc (A4) of each fourth mark 346b neighboring said third mark 346a is either directly or inversely proportional to (r2−R2)/(R3−R2), in FIG. 3B. Accordingly, the change of the radial position (on the extreme inner radius or on the extreme outer radius) on the optical disc I will not result in the distortions of the first patterns 342 and the second patterns 346.

In one embodiment, the third radius (R3) is equal to (2*R2−R1).

In one embodiment shown in FIG. 3A and FIG. 3B, each of the first patterns 342 is a respective first annular sector pattern. Each the first annular sector pattern 342 is determined by a first central angle (θ1) associated with the optical disc, and N is an integer equal to 2π/θ1. Each of the second annular sector patterns 346 is determined by a second central angle (θ2) associated with the optical disc, and M is an integer equal to 2π/θ2.

In one embodiment shown in FIG. 3A and FIG. 3B, the first central angle (θ1) is equal to the second central angle (θ2), and N is equal to M.

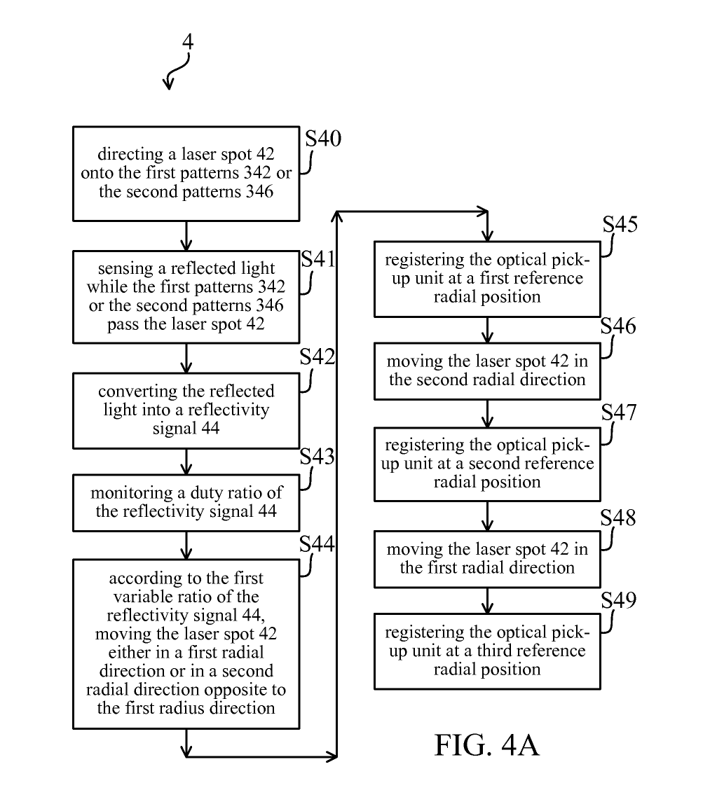

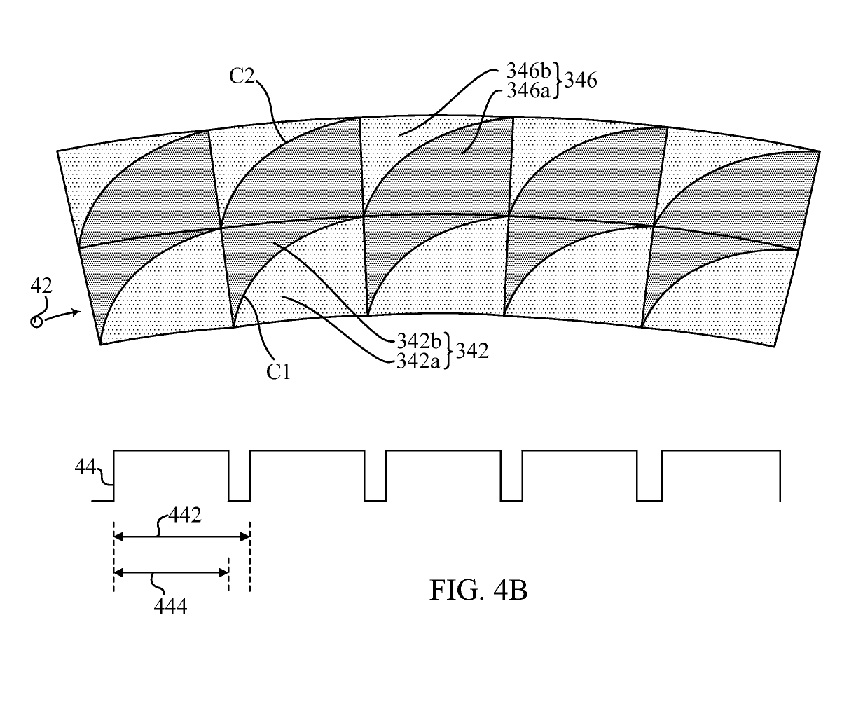

Please refer to FIG. 4A and FIG. 4B. Those two figures disclose the flow charts of the registering method 4 of an optical disc 1 according to the third preferred embodiment of the invention. The registering method 4 registers an optical pick-up unit (not shown in the figures) of an optical information recording apparatus (not shown in the figures) at at least one reference radial position on the non-data side (or the label side) 14 of the optical disc 1.

As shown in FIG. 4A and FIG. 4B, the registering method 4 performs step S40 first Step S40 directs a laser spot 42 emitted by the optical pick-up unit onto the first patterns 342 or onto the second patterns 346 in accordance with the third preferred embodiment of the invention while the optical disc rotates.

Next, step S41 is performed to sense a reflected light while the first patterns 342 or the second patterns 346 pass the laser spot 42.

Next, step S42 is performed to convert the reflected light into a reflectivity signal 44, as shown in FIG. 4B.

Next, step S43 is performed to monitor a duty ratio of the reflectivity signal 44, namely to monitor the ratio between the pulse duration 444 and the pulse period 442 shown in FIG. 4B.

A point for attention is that the duty ratio of the reflectivity signal 44 is either equal to the first variable ratio between the length of the first arc (A1) of each first mark (342a) and the length of the second arc (A2) of each second mark (342b) neighboring said first mark (342a), or it is equal to the second variable ratio between the length of the third arc (A3) of each third mark (346a) and the length of the forth arc (A4) of each fourth mark (346b) neighboring said third mark (346a) on the basis of the arrangement of the first patterns 342 and the second patterns 346.

After the step S43, the step S44 is performed to selectively move the laser spot 42 either in a first radial direction or in a second radial direction opposite to the first radius direction, in accordance with (completely different with Chinese version) the change in the duty ratio of the reflectivity signal 44. Finally, step S45 is performed to register the optical pick-up unit at a first reference radial position of the at least one reference radial position. At the first reference radial position, the duty ratio of the reflectivity signal 44 is equal to a first predetermined value.

In one embodiment, the first variable ratio is directly proportional to (r1−R1)/(R2−R1), the second variable ratio is inversely proportional to (r2−R2)/(R3−R2), and the first predetermined value is equal to zero. In step S44 of this case, the laser spot 42 is moved along the first radial direction. If the duty ratio of the reflectivity signal 44 decreases in the time being, the laser spot 42 will next be moved in the second radial direction.

In another embodiment, the first variable ratio is inversely proportional to (r1−R1)/(R2−R1), the second variable ratio is directly proportional to (r2−R2)/(R3−R2), and the first predetermined value is equal to 100%. In step S44 of this case, the laser spot 42 is moved in the first radial direction. If the duty ratio of the reflectivity signal 44 increases in the time being, the laser spot 42 is moved in the second radial direction next. As shown in FIG. 4A, in one embodiment, the registering method 4 further performs the step S46. The step S46 is performed to move the laser spot 42 in the second radial direction. Next, the step S47 is performed to register the optical pickup unit at a second reference radial position of the at least one reference radial position. At the second reference radial position, the duty ratio of the reflectivity signal 44 is equal to a second predetermined value.

Furthermore, as shown in FIG. 4A in one embodiment, the registering method 4 further performs the step S48. The step S48 is performed to move the laser spot 42 in the first radial direction. Next, the step S49 is performed to register the optical pick-up unit at a third reference radial position of the at least one reference radial position. At the third reference radial position, the duty ratio of the reflectivity signal 44 is equal to the second predetermined value.

In one embodiment, the second predetermined value is equal to 50%. In this embodiment, the first reference radial position determined by the first predetermined value can be used to determine the extreme inner boundary or the extreme outer boundary of the recordable area for labeling on the non-data side 14 of the optical disc 1. In step S47, the second reference radial position determined by the predetermined value can be used to determine the amplitude of the laser beam departing from the inner diameter of the optical disc. In step S49, the third reference radial position determined by the predetermined value can be used to determine the amplitude of the laser beam approaching the inner diameter of the optical disc.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method for registering an optical pick-up unit at at least one reference radial position on a non-data side of an optical disc, N repeated first patterns being arranged in a first annular region on the non-data side of the optical disc, N being a natural number, each of the first patterns being constructed by a respective first mark with a first reflectivity and a respective second mark with a second reflectivity, the first annular region being determined by a first radius (R1) and a second radius (R2) larger than the first radius (R1), each of the first marks covering a respective first arc determined by a first variable radius (r1), and each of the second marks covering a respective second arc determined by the first variable radius (r1), the first variable radius (r1) being in a range from the first radius (R1) to the second radius (R2), said method comprising the steps of:
(a) directing a laser spot emitted by the optical pick-up unit onto the first patterns while the optical disc rotates;
(b) sensing a reflected light while the first patterns pass the laser spot;
(c) converting the reflected light into a reflectivity signal;
(d) monitoring a duty ratio of the reflectivity signal, wherein the duty ratio of the reflectivity signal is equal to a first variable ratio between the length of the first arc of each first mark and the length of the second arc of the second mark neighboring said one first mark;
(e) according to the first variable ratio, moving the laser spot either in a first radial direction or in a second radial direction opposite to the first radial direction; and
(f) registering the optical pick-up unit at a first reference radial position of the at least one reference radial position where the duty ratio of the reflectivity signal is equal to a first predetermined value.

2. The method of claim 1, wherein the first reflectivity is higher than the second reflectivity, and the first variable ratio is directly proportional to (r1-R1)/(R2-R1).

3. (canceled)

4. The method of claim 1, wherein the second radius (R2) is substantially equal to an extreme outer radius of the optical disc.

5. The method of claim 1, wherein the first radius (R1) is substantially equal to an extreme inner radius of the optical disc.

6. The method of claim 1, wherein each of the first patterns is a respective first annular sector pattern determined by a first central angle (θ₁) associated with the optical disc, and N is an integer equal to 2π/θ₁ .

7. The method of claim 1, further comprising the steps of:
(g) moving the laser spot in the second radial direction; and
(h) registering the optical pick-up unit at a second reference radial position of the at least one reference radial position where the duty ratio of the reflectivity signal is equal to a second predetermined value.

8. The method of claim 7, further comprising the steps of:
(i) moving the laser spot in the first radial direction; and
(j) registering the optical pick-up unit at a third reference radial position of the at least one reference radial position where the duty ratio of the reflectivity signal is equal to a third predetermined value.

9. The method of claim 1, wherein M repeated second patterns are arranged in a second annular region on the non-data side of the optical disc, M is a natural number, each of the second patterns is constructed by a respective third mark with a third reflectivity and a respective fourth mark with a fourth reflectivity, the second annular region is determined by the second radius (R2) and a third radius (R3) larger than the second radius (R2), each of the third marks covers a respective third arc determined by a second variable radius (r2), and each of the fourth marks covers a respective fourth arc determined by the second variable radius (r3), the second variable radius (r2) is in a range from the second radius (R2) to the third radius (R3), in step (a), the laser spot is directed onto either the first patterns or the second patterns, in step (b), the reflecting light is sensed while either the first patterns or the second patterns pass the laser spot, in step (d), the duty ratio of the reflectivity signal is equal to either the first variable ratio or a second variable ratio, the first variable ratio is between the length of the first arc of each first mark and the length of the second arc of the second mark neighboring said one first mark, while the second variable ratio is between the length of the third arc of each third mark and the length of the fourth arc of the fourth mark neighboring said third mark.

10. The method of claim 9, wherein the first reflectivity is higher than the second reflectivity, the third reflectivity is lower than the fourth reflectivity, the first variable ratio is directly proportional to (r1-R1)/(R2-R1), and the second variable ratio is inversely proportional to (r2-R2)/(R3-R2).

11. (canceled)

12. The method of claim 9, wherein each of the first patterns is a respective annular sector pattern determined by a first central angle (θ₁ ) associated with the optical disc, N is an integer equal to 2π/θ₁ each of the second patterns is a respective annular sector pattern determined by a second central angle (θ2) associated with the optical disc, and M is an integer equal to 2π/θ2.

13. The method of claim 12, wherein the first central angle (θ₁ ) is equal to the second central angle (θ2), and N is equal to M.

14. The method of claim 9, wherein the third radius (R3) is equal to (2·R2-R1).

15. (canceled)

16. The method of claim 9, further comprising the steps of:
(g) moving the laser spot in the second radial direction; and
(h) registering the optical pick-up unit at a second reference radial position of the at least one reference radial position where the duty ratio of the reflectivity signal is equal to a second predetermined value.

17. The method of claim 16, further comprising the steps of:
(i) moving the laser spot in the first radial direction; and
(j) registering the optical pick-up unit at a third reference radial position of the at least one reference radial position where the duty ratio of the reflectivity signal is equal to the second predetermined value.

18. An optical disc, comprising:
a data side configured to store data;
a non-data side configured to receive a label; and
N repeated first patterns being arranged in a first annular region on the non-data side of the optical disc, N being a natural number, each of the first patterns being constructed by a respective first mark with a first reflectivity and a respective second mark with a second reflectivity, the first annular region being determined by a first radius (R1) and a second radius (R2) larger than the first radius (R1), each of the first marks covering a respective first arc determined by a first variable radius (r1), and each of the second marks covering a respective second arc determined by the first variable radius (r1), the first variable radius (r1) being in a range from the first radius (R1) to the second radius (R2).

19. (canceled)

20. The optical disc of claim 18, wherein the first reflectivity is lower than the second reflectivity, and a ratio between the length of the first arc of each first mark and the length of the second arc of the second mark neighboring said one first mark being inversely proportional to (r1-R1)/(R2-R1).

21. The optical disc of claim 18, wherein each of the first patterns is a respective first annular sector pattern determined by a first central angle (θ₁ ) associated with the optical disc, and N is an integer equal to 2π/θ₁.

22. The optical disc of claim 18, wherein the second radius (R2) is substantially equal to an extreme outer radius of the optical disc.

23. The optical disc of claim 18, wherein the first radius (R1) is substantially equal to an extreme inner radius of the optical disc.

24. The optical disc of claim 18, further comprising:
M repeated second patterns being arranged in a second annular region on the non-data side of the optical disc, M being a natural number, each of the second patterns being constructed by a respective third mark with third reflectivity and a respective fourth mark with fourth reflectivity, the second annular region being determined by the second radius (R2) and a third radius (R3) larger than the second radius (R2), each of the third marks covering a respective third arc determined by a second variable radius (r2), and each of the fourth marks covering a respective fourth arc determined by the second variable radius (r2), the second variable radius (r2) being in a range from the second radius (R2) to the third radius (R3).

25. (canceled)

26. The optical disc of claim 24, wherein the first reflectivity is lower than the second reflectivity, the third reflectivity is higher than the fourth reflectivity, the first variable ratio between the length of the first arc of the first mark and the length of the second arc of the second mark neighboring said one first mark is inversely proportional to (r1-R1)/(R2-R1), and the second variable ratio between the length of the third arc of the third mark and the length of the fourth arc of the fourth mark neighboring said one third mark is directly proportional to (r2-R2)/(R3-R2).

27. The optical disc of claim 24, wherein each of the first patterns is a respective first annular sector pattern determined by a first central angle (θ1) associated with the optical disc, N is an integer equal to 2π/θ1, each of the second patterns is a respective second annular sector pattern determined by a second central angle (θ2) associated with the optical disc, and M is an integer equal to 2π/74 2.

28. The optical disc of claim 27, wherein the first central angle (θ1) is equal to the second central angle (θ2 ), and N is equal to M.

29. The optical disc of claim 24, wherein the third radius (R3) is equal to (2·R2-R1).

30. The optical disc of claim 24, wherein the third radius (R3) is substantially equal to an extreme outer radius of the optical disc.
